(19) United States
(12) Patent Application Publication
(10) Pub. No.: US 2008/0126807 A1
(43) Pub. Date: May 29, 2008

(54) METHOD AND APPARATUS FOR BLOCKING SPAM DATA, AND METHOD AND APPARATUS FOR TRANSMITTING DATA FOR BLOCKING SPAM DATA

(75) Inventors: Hyok-sung CHOI, Yongin-si (KR); Seong-kook SHIN, Seoul (KR); Se-jun HAN, Daejeon Metropolitan-city (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/835,025

(22) Filed: Aug. 7, 2007

(30) Foreign Application Priority Data
Nov. 24, 2006 (KR) 10-2006-0117099

(51) Int. Cl. H04L 9/00

(52) U.S. Cl. 713/176

(57) ABSTRACT

A method of blocking spam data is provided. The method includes: receiving a digital content file and key data, in which a key, including information for identifying a transmitter, and an electronic signature for the key are inserted as a watermark; and based on the key and the electronic signature for the key inserted in the received key data, selectively blocking the digital content file received with the key data.

### CROSS-REFERENCE TO RELATED PATENT APPLICATIONS

This application claims priority from Korean Patent Application No. 10-2006-0117099, filed on Nov. 24, 2006, in the Korean Intellectual Property Office, the disclosure of which is incorporated herein in its entirety by reference.

### BACKGROUND OF THE INVENTION

1. Field of the Invention

Methods and apparatus consistent with the present invention relate to a method and apparatus for blocking spam data.

2. Description of the Related Art

With widespread penetration of Internet and wireless communication apparatuses in a wide range of fields, it has become easier for transmitters to transmit messages or emails to many receivers at a cheaper price or for free. As transmission of messages or emails to many receivers has become easier, reception of messages or emails that receivers do not want to receive, that is, spam data, has been increasing more and more. This spam data is different from ordinary commercial mail in that the spam data is transmitted unilaterally even though a receiver does not agree to provide his or her email address or mobile phone number.

In order to block this received spam data, many methods have been suggested.

Firstly, there is a method in which if a transmitter of data is not included in a preselected group, the data transmitted by the transmitter is blocked. According to this method, even though the data may include required information, if the transmitter is not included in a group, whose data is desired to be received, by mistake or for other reasons, the required information may not be received.

Secondly, there is a method in which a receiver stores an identification (ID), email address, and Internet protocol (IP) address of a spam data transmitter in order to make a blacklist, and information received from the ID, email address, and IP address of the transmitter is blocked.

However, in this method, if the transmitter transmitting spam mails does not use his/her ID, email address and IP address, but uses another arbitrary ID, email address, and IP address to transmit spam data, the spam data cannot be blocked.

Thirdly, there is a method in which if a predetermined word is included in the title of spam data being received, the spam data is not received.

However, according to this method, if transmitters transmitting spam data frequently change the predetermined words included in a title and transmit the data, the transmitted data cannot be blocked.

Thus, the conventional spam data blocking methods cannot effectively block spam data.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

The present invention provides a method and apparatus capable of effectively blocking spam data, and a method of transmitting data for blocking spam data.

According to an aspect of the present invention, there is provided a method of blocking spam data including: receiving key data, in which a key, including information for identifying a transmitter, and an electronic signature for the key are inserted as a watermark, and a digital content file; and based on the key and the electronic signature for the key inserted in the received key data, selectively blocking the digital content file received together with the key data.

The selective blocking of the digital content file may further include, if the digital content file is not blocked, removing the watermark from the key data received together with the digital content file, and then, transmitting the digital content file and the key data, from which the watermark is removed.

The selective blocking of the digital content file may further include, if the digital content file is not blocked, transmitting the digital content file and the key data together.

In the transmitting of the digital content file and the key data, if transmitter identification data for identifying a transmitter exists in addition to the key data, from which the watermark is removed, the data for identifying the transmitter instead of the key data may be transmitted together with the digital content file.

The selective blocking of the digital content file may include: extracting the key and the electronic signature for the key from the received key data; based on the extracted key and the electronic signature for the key, determining a valid period of the key and genuineness of the key; and based on the result of determining the valid period and genuineness of the key, selectively blocking the received digital content file.

The method may further include, if the result of the determining indicates that the valid period of the key has not expired and the genuineness of the key is confirmed, determining whether or not the transmitter transmitting the digital content file is a legitimate transmitter.

According to another aspect of the present invention, there is provided a method of transmitting data for blocking spam data, including transmitting key data, in which a key, including information for identifying a transmitter, and an electronic signature for the key are inserted as a watermark, together with a digital content file.

In the transmitting of the key data and the digital content file, an apparatus control command to control an apparatus receiving the digital content file may be transmitted together with the key data and the digital content file.

The apparatus control command may include at least one of a command to turn on or off the apparatus receiving the apparatus control command, and a command to output the received digital content file onto a screen.

According to another aspect of the present invention, there is provided a method of generating data for identifying a transmitter including: receiving data to be used for generating data for identifying the transmitter; based on the received data, extracting information for identifying the transmitter transmitting data; generating a key including the extracted information for identifying the transmitter, and generating an electronic signature for the key; and inserting the generated key and electronic signature for the key, as a watermark, into the received data.

The data to be used for generating the data for identifying the transmitter may include an image, moving pictures, audio and text.

According to another aspect of the present invention, there is provided a method of notifying about reception of a digital content file, including: receiving the digital content file and data for identifying a transmitter together; and based on the data for identifying the transmitter, outputting notification of the reception of the digital content file onto a screen.

The data for identifying the transmitter may include one of images, moving pictures, audio and text.

According to another aspect of the present invention, there is provided a method of notifying about reception of a digital content file received by using a method of blocking spam data, the notifying method including: receiving key data, in which a key, including information for identifying a transmitter, and an electronic signature for the key are inserted as a watermark, and a digital content file together; based on the key and the electronic signature for the key inserted into the received key data, selectively blocking the digital content file received together with the key data; and if the digital content file is not blocked in the selective blocking, outputting notification of the reception of the digital content onto a screen based on the digital content file and the received key data.

In the outputting notification of the reception, if the digital content file is not blocked in the selective blocking, the watermark may be removed from the key data received together with the digital content file, and then, based on the key data, from which the watermark is removed, notification of the reception of the digital content file may be output onto the screen.

According to another aspect of the present invention, there is provided an apparatus for blocking spam data including: a reception unit receiving key data, in which a key, including information for identifying a transmitter, and an electronic signature for the key are inserted as a watermark, and a digital content file; and a spam blocking unit selectively blocking the digital content file received together with the key data, based on the key and the electronic signature for the key inserted into the received key data.

According to another aspect of the present invention, there is provided an apparatus for generating data for identifying a transmitter including: a reception unit receiving data to be used for generating data for identifying the transmitter; an extraction unit extracting information for identifying the transmitter transmitting data, based on the received data; a key generation unit generating a key including the extracted information for identifying the transmitter, and generating an electronic signature for the key; and a watermark insertion unit inserting the generated key and electronic signature for the key, as a watermark, in the received data.

According to another aspect of the present invention, there is provided an apparatus for notifying about reception of a digital content file, including: a reception unit receiving the digital content file and data for identifying a transmitter together; and a notification unit outputting notification of the reception of the digital content file onto a screen, based on the data for identifying the transmitter.

According to another aspect of the present invention, there is provided an apparatus for notifying about reception of a digital content file received by using a method of blocking spam data, the apparatus including: a reception unit receiving key data, in which a key, including information for identifying a transmitter, and an electronic signature for the key are inserted as a watermark, and a digital content file together; a spam blocking unit selectively blocking the digital content file received together with the key data, based on the key and the electronic signature for the key inserted into the received key data; and a notification unit, if the digital content file is not blocked in the selective blocking, outputting notification of the reception of the digital content onto a screen based on the digital content file and the received key data.

According to still another aspect of the present invention, there is provided a computer readable recording medium having embodied thereon a computer program for executing the methods for blocking spam data.

According to still another aspect of the present invention, there is provided a computer readable recording medium having embodied thereon a computer program for executing the methods for transmitting data for blocking spam data.

### BRIEF DESCRIPTION OF THE DRAWINGS

The above and other features and aspects of the present invention will become more apparent by describing in detail exemplary embodiments thereof with reference to the attached drawings in which:

FIG. 1 is a diagram illustrating an apparatus for blocking spam data according to an exemplary embodiment of the present invention;

FIG. 2 is a diagram for explaining a method of receiving key data and digital content files together according to an exemplary embodiment of the present invention;

FIG. 3 is a diagram illustrating a process of receiving key data according to an exemplary embodiment of the present invention;

FIG. 4 is a diagram for explaining a method of blocking spam data according to an exemplary embodiment of the present invention;

FIG. 5 is a flowchart of a method of blocking spam data according to an exemplary embodiment of the present invention;

FIG. 6 is a diagram illustrating an apparatus for generating key data according to an exemplary embodiment of the present invention; and

FIG. 7 is a flowchart of a method of generating data for blocking spam data according to an exemplary embodiment of the present invention.

### DETAILED DESCRIPTION OF THE INVENTION

The present invention will now be described more fully with reference to the accompanying drawings, in which exemplary embodiments of the invention are shown.

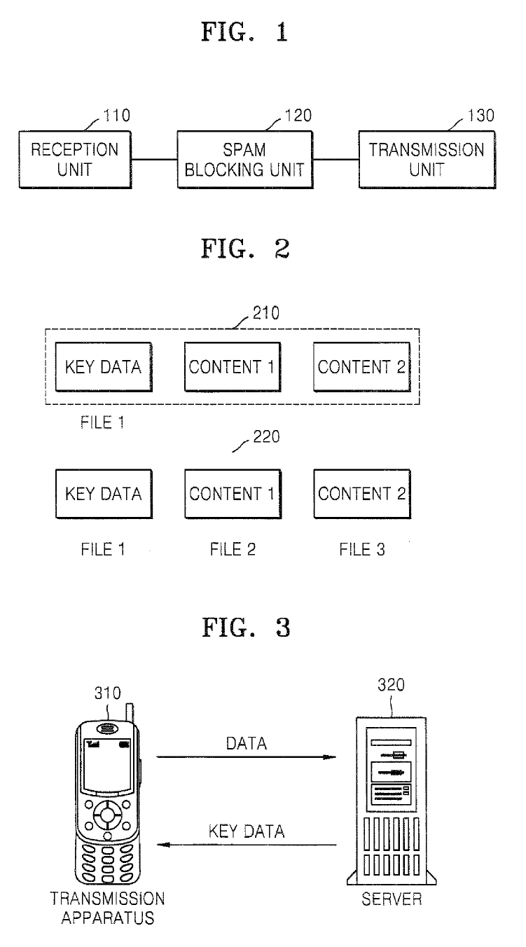

FIG. 1 is a diagram illustrating an apparatus for blocking spam data according to an exemplary embodiment of the present invention.

Referring to FIG. 1, the apparatus for blocking spam data according to the current exemplary embodiment is composed of a reception unit 110, a spam blocking unit 120, and a transmission unit 130.

The reception unit 110 receives key data and a digital content file. In the key data, a key, including information for identifying a transmitter, and an electronic signature are inserted as a watermark. When a transmitter that wants to transmit a digital content file wants to receive a digital content file for the first and only time, the digital content file is stored, and then transmitted together with the key data.

FIG. 2 is a diagram for explaining a method of receiving key data and digital content files together according to an exemplary embodiment of the present invention.

Referring to FIG. 2, key data and digital content files can be received in the form of one integrated file as indicated by reference numeral 210. Also, as indicated by reference numeral 220, key data and digital content files may be received in the form of a plurality of separate files. For example, when an email is transmitted, in the case of the format 210, the key data and digital content files are combined as one file, and only this file is attached to the email message and transmitted. In the case of the format 220, when an email is transmitted, the key data and the digital content files, i.e., Content 1 and Content 2, are attached to the email as three separate files, and then transmitted.

Here, the key data and the digital content files may be transmitted by using a variety of transmission methods, such as a multimedia message system (MMS) message of a mobile phone, in addition to the email transmission.

If the key data and the digital content files are transmitted as one file in the format 210, management of only one file is required, thereby providing convenience of transmission. However, after that time, when it is determined whether or not to block digital content files, a separate process for extracting key data from one file is required, thereby causing inconvenience.

Meanwhile, if the key data and the digital content files are transmitted as many files as in the format 220, management for transmission of the files is inconvenient, but after the transmission, when it is determined whether or not to block digital content files, a separate process of extracting the key data is not necessary, because the key data is already disclosed.

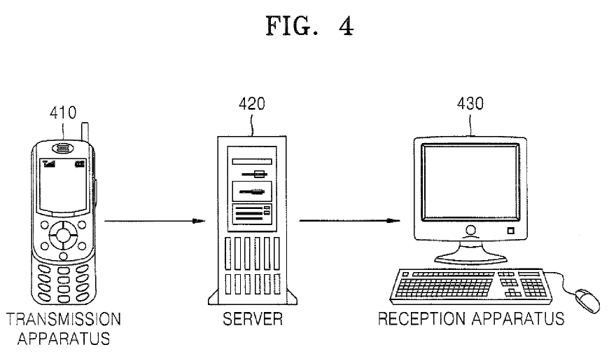

When the key data and the digital content files are transmitted, a control command for controlling an apparatus receiving the digital content files may also be transmitted together with the key data and the digital content files. The apparatus control command will be explained later with reference to FIG. 4.

FIG. 3 is a diagram illustrating a process of receiving key data according to an exemplary embodiment of the present invention.

Referring to FIG. 3, a transmitter transmits data that is to be used for generating key data, to a server 320, by using a transmission apparatus 310, for example a mobile phone or a personal computer (PC). Here, the key data becomes data for identifying the transmitter, and the data to be used for generating the key data includes all data in which a watermark can be inserted, such as image, audio and video data.

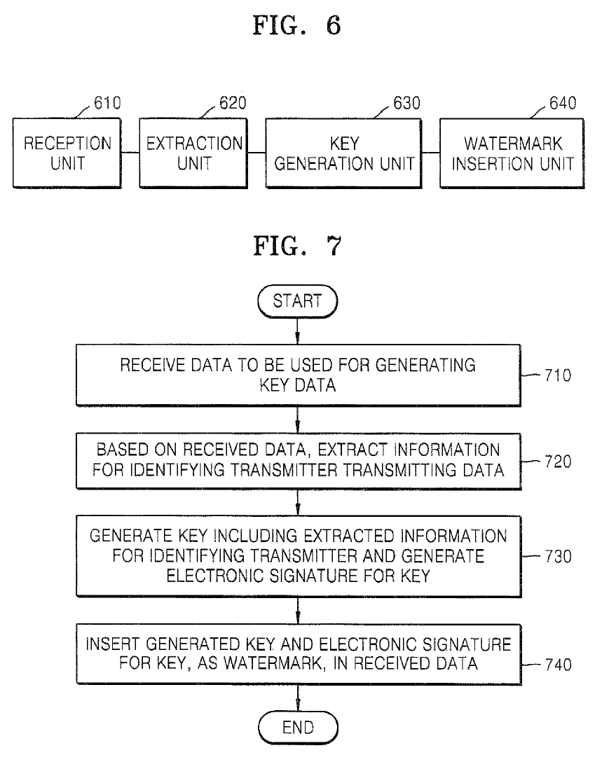

If the data from the transmission apparatus 310 is received, the server 320 extracts the information for identifying the transmitter from the received data, and then generates key data, by inserting a key including the transmitter information as a watermark. Then, the server 320 retransmits the generated key data to the transmission apparatus 3 10. A method of generating key data according to an exemplary embodiment of the present invention will be explained later with reference to FIGS. 6 and 7.

Here, information for identifying the transmitter may be, for example, a mobile phone number of the transmitter transmitting data for generating the key data when the data is transmitted by using a mobile phone. When the data is transmitted by using a PC, the information may be an ID or the name of the transmitter. Also, in addition to the transmitter information, additional information, such as a valid period of a key may be further included.

The spam blocking unit 120 selectively blocks a digital content file received together with key data, based on a key and an electronic signature for the key inserted into the key data.

When the spam blocking unit 120 does not block a digital content file, the transmission unit 130 removes a watermark from key data received together with the digital content file, and then, transmits the digital content file and the key data from which the watermark is removed.

In this case, when the digital content file is not blocked, the transmission unit 130 may transmit the key data received together with the digital content file without removing the watermark. The reason why the watermark is removed from the key data is that if key data including a watermark is transmitted, a person who receives the key data may obtain the right of the transmitter who transmits the key data, thereby causing a security problem. However, depending on implementations, this security problem may be solved, and if the security problem is solved by implementations, the key may be transmitted without removing the watermark.

When separate transmitter identification data for identifying a transmitter exists in addition to the key data from which a watermark is removed, the transmitter identification data can be transmitted together with the digital content file.

In this case, the data for identifying a transmitter indicates data with which the transmitter can be identified, such as a photo of the transmitter. The data for identifying a transmitter is not limited to the photo of the transmitter and includes all data allowing the transmitter to be identified.

Also, when a command to control an apparatus for receiving the digital content file is received together with the key data and the digital content file, the key data, from which the watermark is removed, the digital content file and the apparatus control command for controlling the apparatus are transmitted together.

The apparatus receiving the digital content coupled with the apparatus control command performs operations according to the apparatus control command.

FIG. 4 is a diagram for explaining a method of blocking spam data according to an exemplary embodiment of the present invention.

Referring to FIG. 4, a transmission apparatus 410, for example, a mobile phone or a PC, first transmits key data together with a digital content file to a server 420.

The server 420 receiving the key data together with the digital content file determines, based on the key and the electronic signature for the key of the digital content file, whether block the received digital content file. If the digital content file is not blocked, the server 420 removes a watermark from the key data received together with the digital content file, and then, transmits the key data, from which the watermark is removed, and the digital content file to a reception apparatus 430.

If the digital content file and the key data, from which the watermark is removed, are received, the reception apparatus 430 displays on a screen of the reception apparatus 430, the information that the digital content file is received. In this case, this reception information may be displayed by using text or graphics.

Also, in this case, when the key data from which the watermark is removed is received, the reception apparatus outputs the key data onto the screen, and when the separate data for identifying a transmitter is received, the reception apparatus 430 outputs the data onto the screen, thereby allowing the transmitter to be identified through the screen.

For example, when the key data from which the watermark is removed or the data for identifying the transmitter is an image, the image is output and when the key data or the transmitter identification data is moving pictures, the moving pictures are displayed on the screen.

In this way, when the key data or the transmitter identification data is received together with the digital content file, even if the transmitter transmits the digital content file by using any one of a mobile phone, a personal digital assistant (PDA), and a PC, the received digital content file can be classified as a digital content file received from the same transmitter, thereby allowing the reception apparatus 430 to more easily classify and use digital content files.

Meanwhile, when the apparatus control command is received together with the digital content file, the reception apparatus 430 performs operations according to the apparatus control command. As described above, the apparatus control command may be a command to turn on or off the apparatus, a command to output an image, or a command to reproduce moving pictures.

However, even when this apparatus control command is received by the reception apparatus 430, if the reception apparatus 430 is set so as not to follow the apparatus control command, or a control right is only given to a predetermined transmitter, the operations according to the apparatus control command may not be performed.

For example, assuming that a control right is given to the owner of the reception apparatus 430 or to family members of the owner, and if the result of reading the received key data indicates that a transmitter transmitting a control command is not the owner of the reception apparatus 430 or a member of the family of the owner, operations according to the control command are not performed even though the control command is received.

The explanation so far relates to the case where the apparatus for blocking spam data is mounted on the server 420. However, the apparatus for blocking spam data may be mounted to the reception apparatus 430. That is, when the apparatus for blocking spam data is mounted on the reception apparatus 430, the server 420 performs only a function of transmitting a digital content file received from the transmission apparatus 410 to the reception apparatus 430, and does not perform the function of blocking a digital content file. The function of blocking a digital content file is performed by the reception apparatus 430 itself

When the apparatus for blocking spam data is mounted on the reception apparatus 430, the reception apparatus 430 may generate key data and retransmit the key data to the transmission apparatus 41 0.

In other words, the reception apparatus 430 receives a request to generate key data, data required for generating the key data, and transmitter information from the transmission apparatus 410. Then, according to the setting of the reception apparatus 430 or selection by a user, the reception apparatus 430 inserts a key including the transmitter information as a watermark, thereby generating key data, and then, retransmits the key data to the transmission apparatus 41 0.

Also, depending on implementations, the transmission apparatus 410 may transmit key data and a digital content file to the reception apparatus 430 without a server 420. Also, in this case, the reception apparatus 430 performs the function of blocking a digital content file.

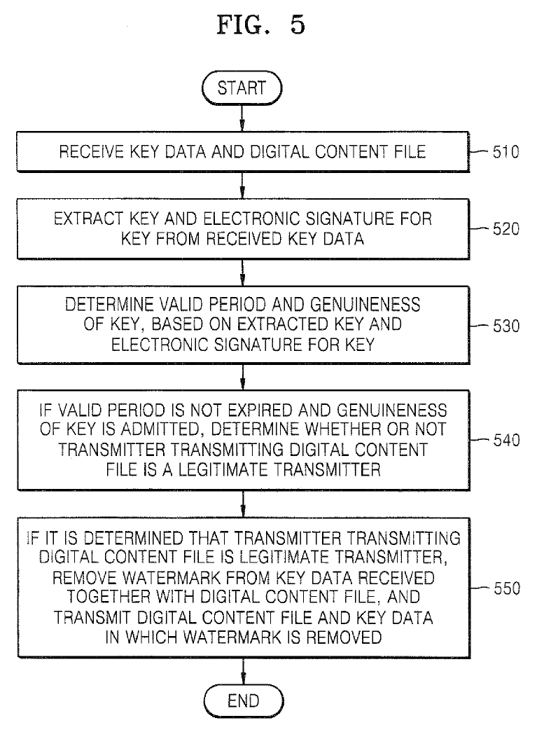

FIG. 5 is a flowchart of a method of blocking spam data according to an exemplary embodiment of the present invention.

In operation 510, key data and a digital content file are received together.

As described above, when the digital content file is received, an apparatus control command for controlling the apparatus receiving the digital content may be received together with the digital content file.

In operation 520, a key and an electronic signature for the key are extracted from the received key data.

In operation 530, a valid period of the key and the genuineness of the key are determined based on the extracted key and electronic signature for the key.

Here, the valid period of the key is included together with the key. The reason why the valid period of the key is determined is to confirm that a transmitter transmitting data by using the key is not a person transmitting spam data, but a legitimate transmitter. That is, when a key is generated in a server, a valid period is set, and when the data is transmitted by using the key data within the valid period, the transmitted data is recognized as normal data, not spam data. This setting of a valid period can be effectively used for the case where email or data is transmitted by using a server that has a regulation of charging for transmission of an email or mobile phone data.

Also, the genuineness of the electronic signature of a key can be evaluated by an external evaluation organization, thereby confirming the genuineness of the key.

The reason why the genuineness of the key is determined is to determine whether or not the key data including the key is forged or counterfeited, or whether or not the key data is fraudulently used.

In operation 540, if the valid period of the key has not expired and the genuineness of the key is confirmed, it is determined whether the transmitter transmitting the digital content file is a legitimate transmitter.

In this case, the legitimate transmitter is a person who does not have reasons for disqualification, such as an illegal transmitter, a person with a previous record of transmitting spam mail, and a fee defaulter.

For example, the illegal transmitter is a person who illegally uses a key medium, or who has previously distributed illegal software, thereby having been registered in an illegal transmitter list. The person with a previous record of transmitting spam mail is a person who previously transmitted spam mail, thereby having been registered in a spam mail transmitter list. Also, the fee defaulter is a person who transmitted data, by using a server that has a regulation of charging for transmission of an email or mobile phone data, but did not pay the fees for the transmission. Based on the list of illegal transmitters, the list of spam mail transmitters, and the list of fee defaulters, the spam blocking unit 120 determines whether the transmitter transmitting the digital content file is a legitimate transmitter.

The reason why it is determined in operation 540 whether the transmitter is a legitimate transmitter is to restrict transmission by the transmitter if the transmitter is included in the list of the illegal transmitters, the list of the spam mail transmitter, or the list of fee defaulters in operation 540, even though the transmitter transmits the digital content file by using the key data authenticated in operation 530.

In operation 550, if it is determined that the transmitter transmitting the digital content file is a legitimate transmitter, a watermark is removed from the key data received together with the digital content file, and then, the digital content file and the key data, from which the watermark is removed, are transmitted.

In this case, as described above, if the apparatus control command for controlling the apparatus receiving the digital content file is received together with the key data and the digital content file, the apparatus control command is transmitted together with the digital content file. Also, as described above, if separate data for identifying the transmitter exists in addition to the key data, the data for identifying the transmitter can be transmitted instead of the key data.

Also, as described above, depending on implementations, key data from which the watermark is not removed, and the digital content file may be transmitted.

FIG. 6 is a diagram illustrating an apparatus for generating key data according to an exemplary embodiment of the present invention.

Referring to FIG. 6, the apparatus for generating key data according to the current exemplary embodiment is composed of a reception unit 610, an extraction unit 620, a key generation unit 630, and a watermark insertion unit 640.

The reception unit 610 receives data to be used for generating data for identifying a transmitter.

As described above, the data for identifying a transmitter is data with which the transmitter can be identified, such as a photo of the transmitter. The data for identifying a transmitter is not limited by formats, such as image, audio, and video formats.

Based on the received data, the extraction unit 620 extracts information for identifying a transmitter transmitting data.

As described above, the received data may include a mobile phone number, or an email address of the transmitter transmitting the data, or a transmitter identification (ID), and this information becomes the information for identifying the transmitter.

The key generation unit 630 generates a key including the extracted information for identifying the transmitter, and generates an electronic signature for the key.

The watermark insertion unit 640 inserts the generated key and the electronic signature for the key as a watermark, into the received data.

FIG. 7 is a flowchart of a method of generating data for blocking spam data according to an exemplary embodiment of the present invention.

In operation 710, data to be used for generating key data is received.

In operation 720, based on the received data, information for identifying a transmitter transmitting data is extracted.

In operation 730, a key including the extracted information for identifying the transmitter is generated and an electronic signature for the key is generated.

Here, as described above, additional information, such as a valid period of the key itself, can also be included.

In operation 740, the generated key and the electronic signature for the key are inserted as a watermark into the received data.

If the key including the information for identifying the transmitter and the electronic signature for the key are inserted as a watermark into the received data in this way, key data is generated, and the thus generated key data is retransmitted to the transmission apparatus.

According to the method and apparatus of the present invention as described above, spam data can be effectively blocked.

The present invention can also be embodied as computer readable codes on a computer readable recording medium. The computer readable recording medium is any data storage device that can store data which can be thereafter read by a computer system.

Examples of the computer readable recording medium include read-only memory (ROM), random-access memory (RAM), CD-ROMs, magnetic tapes, floppy disks, and an optical data storage devices.

While the present invention has been particularly shown and described with reference to exemplary embodiments thereof, it will be understood by those of ordinary skill in the art that various changes in form and details may be made therein without departing from the spirit and scope of the present invention as defined by the following claims. The exemplary embodiments should be considered in a descriptive sense only and not for purposes of limitation. Therefore, the scope of the invention is defined not by the detailed description of the invention but by the appended claims, and all differences within the scope will be construed as being included in the present invention.

What is claimed is:

1. A method of blocking spam data, the method comprising:
receiving a digital content file, and key data in which a key, including information for identifying a transmitter, and an electronic signature for the key are inserted as a watermark; and
selectively blocking the digital content file received with the key data based on the key and the electronic signature for the key inserted in the received key data.

2. The method of claim 1, wherein the selectively blocking the digital content file further comprises, if the digital content file is not blocked, removing the watermark from the key data received with the digital content file, and transmitting the digital content file and the key data from which the watermark is removed.

3. The method of claim 1, wherein the selectively blocking the digital content file further comprises, if the digital content file is not blocked, transmitting the digital content file with the key data.

4. The method of claim 2, wherein in the transmitting the digital content file and the key data from which the watermark is removed, if transmitter identification data for identifying the transmitter exists in addition to the key data from which the watermark is removed, the transmitter identification data, instead of the key data, is transmitted with the digital content file.

5. The method of claim 1, wherein the selectively blocking the digital content file comprises:
extracting the key and the electronic signature for the key from the key data;
determining a valid period of the key and genuineness of the key based on the extracted key and the electronic signature for the key; and
selectively blocking the received digital content file based on the result of determining the valid period and the genuineness of the key.

6. The method of claim 5, further comprising, if a result of the determining indicates that the valid period of the key has not expired and the genuineness of the key is confirmed, determining whether the transmitter transmitting the digital content file is a legitimate transmitter.

7. A method of transmitting data for blocking spam data, the method comprising transmitting key data, in which a key, including information for identifying a transmitter, and an electronic signature for the key are inserted as a watermark, with a digital content file.

8. The method of claim 7, wherein in the transmitting the key data and the digital content file, an apparatus control command for controlling an apparatus receiving the digital content file is transmitted with the key data and the digital content file.

9. The method of claim 8, wherein the apparatus control command comprises at least one of a command to turn on or off the apparatus receiving the apparatus control command, and a command to output the received digital content file onto a screen.

10. A method of generating data for identifying a transmitter, the method comprising:
receiving data to be used for generating data for identifying a transmitter transmitting the data;
based on the data, extracting information for identifying the transmitter;
generating a key including the information for identifying the transmitter, and generating an electronic signature for the key; and
inserting the key and the electronic signature for the key, as a watermark, into the data, which is received.

11. The method of claim 11, wherein the data to be used for generating the data for identifying the transmitter comprises at least one of an image, a moving picture, audio and text.

12. A method of notifying about reception of a digital content file, the method comprising:
receiving the digital content file with data for identifying a transmitter; and
outputting notification of the receiving of the digital content file onto a screen based on the data for identifying the transmitter.

13. The method of claim 12, wherein the data for identifying the transmitter comprises at least one of an image, a moving picture, audio and text.

14. A method of notifying about reception of a digital content file received by using a method of blocking spam data, the method comprising:
receiving key data, in which a key, including information for identifying a transmitter, and an electronic signature for the key are inserted as a watermark, with a digital content file;
selectively blocking the digital content file received with the key data based on the key and the electronic signature for the key inserted into the received key data; and
if the digital content file is not blocked in the selectively blocking, outputting notification of the receiving of the digital content onto a screen based on the digital content file and the key data.

15. The method of claim 14, wherein in the outputting notification the receiving of the digital content onto the screen, if the digital content file is not blocked in the selectively blocking, the watermark is removed from the key data received with the digital content file, and, notification of the receiving of the digital content file is output onto the screen based on the key data from which the watermark is removed.

16. An apparatus for blocking spam data, the apparatus comprising:
a reception unit which receives a digital content file and key data, in which a key, including information for identifying a transmitter which transmits the digital content file, and an electronic signature for the key are inserted as a watermark; and
a spam blocking unit which selectively blocks the digital content file received with the key data, based on the key and the electronic signature for the key inserted into the received key data.

17. The apparatus of claim 16, further comprising a transmission unit, which, if the digital content file is not blocked in the spam blocking unit, removes the watermark from the key data received with the digital content file, and, transmits the digital content file and the key data from which the watermark is removed.

18. The apparatus of claim 16, further comprising a transmission unit which, if the digital content file is not blocked in the spam blocking unit, the transmission unit transmits the digital content file together with the key data.

19. The apparatus of claim 17, wherein if transmitter identification data for identifying a transmitter exists in addition to the key data from which the watermark is removed, the transmission unit transmits the transmitter identification data, instead of the key data, with the digital content file.

20. The apparatus of claim 16, wherein the spam blocking unit extracts the key and the electronic signature for the key from the received key data, determines a valid period of the key and genuineness of the key based on the extracted key and the electronic signature for the key, and, selectively blocks the received digital content file based on the result of determining the valid period and the genuineness of the key.

21. The apparatus of claim 20, wherein if a result of the determining indicates that the valid period of the key has not expired and the genuineness of the key is confirmed, the spam blocking unit determines whether or not the transmitter is a legitimate transmitter.

22. An apparatus for transmitting data for blocking spam data, the apparatus comprising:
a transmission unit which transmits key data, in which a key, including information for identifying a transmitter, and an electronic signature for the key are inserted as a watermark, with a digital content file.

23. The apparatus of claim 22, wherein an apparatus control command for controlling an apparatus receiving the digital content file is transmitted with the key data and digital content file.

24. The apparatus of claim 23, wherein the apparatus control command comprises at least one of a command to turn on or off the apparatus receiving the apparatus control command, and a command to output the received digital content file onto a screen.

25. An apparatus for generating data for identifying a transmitter the apparatus comprising:
a reception unit which receives data to be used for generating data for identifying the transmitter;
an extraction unit which extracts information for identifying the transmitter, based on the data;
a key generation unit which generates a key including the extracted information for identifying the transmitter, and generates an electronic signature for the key; and
a watermark insertion unit which inserts the key and the electronic signature for the key, as a watermark, in the data.

26. The apparatus of claim 25, wherein the data to be used for generating the data for identifying the transmitter comprises at least one of an image, a moving picture, audio and text.

27. An apparatus for notifying about reception of a digital content file, the apparatus comprising:
a reception unit which receives the digital content file with data for identifying a transmitter; and
a notification unit which outputs notification of the receiving of the digital content file onto a screen, based on the data for identifying the transmitter.

28. The apparatus of claim 27, wherein the data for identifying the transmitter comprises at least one of an image, a moving picture, audio and text.

29. An apparatus for notifying about reception of a digital content file received by using a method of blocking spam data, the apparatus comprising:
a reception unit which receives key data, in which a key, including information for identifying a transmitter, and an electronic signature for the key are inserted as a watermark, with a digital content file;
a spam blocking unit which selectively blocks the digital content file received with the key data, based on the key and the electronic signature for the key inserted into the key data; and
a notification unit which, if the digital content file is not blocked in the selective blocking, outputs notification of the receiving of the digital content onto a screen based on the digital content file and the key data.

30. The apparatus of claim 29, wherein if the digital content file is not blocked in the spam blocking unit, the watermark is removed from the key data received with the digital content file, and, the notification unit outputs the receiving of the digital content file onto the screen based on the key data from which the watermark is removed.

31. A computer readable recording medium having embodied thereon a computer program for executing the method of claim 1.
